(19) United States
(12) Patent Application Publication
(10) Pub. No.: US 2017/0328381 A1
(43) Pub. Date: Nov. 16, 2017

(54) ACTUATOR AND CHANNEL COMPONENT

(71) Applicants: Kabushiki Kaisha Toshiba, Minato-ku (JP); TOKYO INSTITUTE OF TECHNOLOGY, Meguro-ku (JP)

(72) Inventors: Tatsuhiko GOTO, Kawasaki (JP); Junichiro OOGA, Kawasaki (JP); Koichi SUZUMORI, Meguro (JP)

(73) Assignees: Kabushiki Kaisha Toshiba, Minato-ku (JP); TOKYO INSTITUTE OF TECHNOLOGY, Meguro-ku (JP)

(21) Appl. No.: 15/442,910

(22) Filed: Feb. 27, 2017

(30) Foreign Application Priority Data
May 13, 2016 (JP) 2016-096753

(51) Int. Cl. F15B 11/16; F15B 13/06; F15B 15/10

(52) U.S. Cl. CPC F15B 11/16; F15B 15/103; F15B 13/06; F15B 2211/71

(57) ABSTRACT

According to one embodiment, an actuator includes a plurality of channel members each including a first port into which fluid flows and a second port from which the fluid flows out. At least one of the channel members includes a different number of second ports from a number of first ports.

### CROSS-REFERENCE TO RELATED APPLICATIONS

This application is based upon and claims the benefit of priority from Japanese Patent Application No. 2016-096753, filed on May 13, 2016; the entire contents of which are incorporated herein by reference.

### FIELD

Embodiments described herein relate generally to an actuator and a channel component.

### BACKGROUND

Conventionally, an actuator that operates by a fluid supply is known.

It is useful to provide an actuator or a channel component having a novel structure with less inconvenience, e.g., a simpler structure.

### BRIEF DESCRIPTION OF THE DRAWINGS

FIG. 1 is a schematic illustrating an exemplary general configuration of an actuator according to a first embodiment;

FIG. 2 is a table representing the numbers of actuator elements to operate by switching an ON state and an OFF state of switching valves, and resultant output values in the actuator according to the first embodiment;

FIG. 3 is a schematic illustrating an exemplary general configuration of an actuator according to a second embodiment; and

FIG. 4 is a table representing the numbers of the actuator elements to operate by switching the ON state and the OFF state of switching valves, and resultant output values in the actuator according to the second embodiment.

### DETAILED DESCRIPTION

In general, according to one embodiment, an actuator includes a plurality of channel members each including a first port into which fluid flows and a second port from which the fluid flows out. At least one of the channel members includes a different number of second ports from a number of first ports.

In general, according to one embodiment, a channel component includes a plurality of channel members each including a first port into which fluid flows and a second port from which the fluid flows out. At least one of the channel members includes a different number of second ports from a number of first ports.

An actuator according to exemplary embodiments will now be disclosed. The configurations and the controls (the technical features) described in the embodiments below, and the effects and the results (advantages) achieved by these configurations and controls are provided by way of examples only.

The following embodiments include same or like elements. Hereunder, the same reference numerals are assigned to the same or like elements, and redundant explanations thereof may be omitted.

### First Embodiment

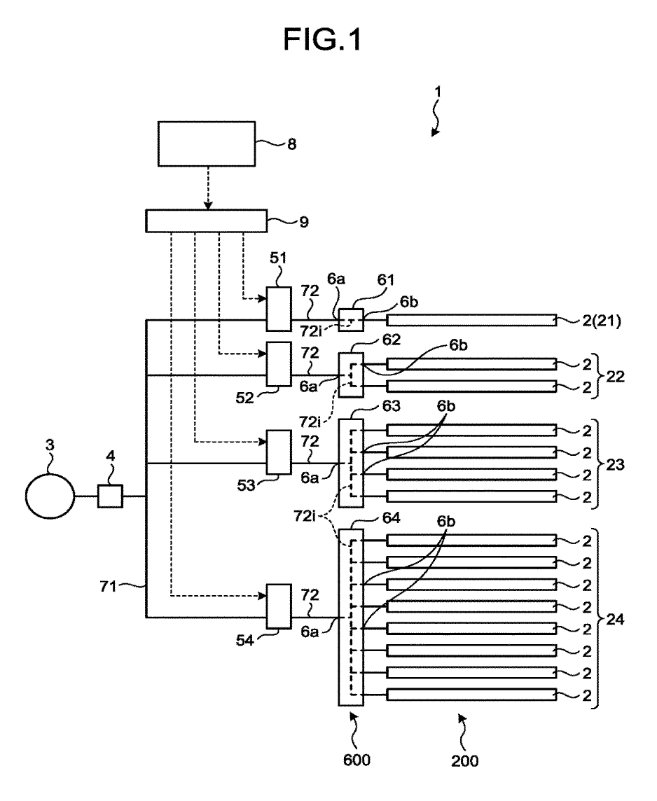

FIG. 1 is a schematic of a general configuration of an actuator according to a first embodiment. As illustrated in FIG. 1, an actuator 1 includes multiple actuator elements 2 that are arranged in parallel. Hereinafter, the entire actuator elements 2 of the actuator 1 are referred to as an actuator element group 200.

The actuator element 2 is placed in an operating state or a supplied state when supplied with fluid to output a predetermined output value, and placed in a non-operating state or a non-supplied state when the fluid supply is stopped or the fluid is discharged.

The actuator elements 2 are McKibben artificial muscles, for example. A McKibben artificial muscle includes a tube that is made of an elastic, expandable and contractible material such as elastomer and has a closed longitudinal end, and a mesh made from synthetic fibers surrounding the tube, for example. The McKibben artificial muscle expands radially (short-side direction) and contracts axially during the supplied state when supplied into the tube with gas (air) as the fluid, to generate a tensile force (contraction) that pulls both axial ends (operating state). By contrast, during the non-supplied state in which the gas is discharged from the tube, the McKibben artificial muscle contracts radially and becomes stretched axially due to the elastic force of the tube and the mesh, for example, and recovers its original shape (non-operating state). With use of McKibben artificial muscles for the actuator elements 2, the output value from the actuator elements 2 represents a tensile force (contraction), for example.

As illustrated in FIG. 1, the actuator elements 2 are arranged in parallel. In the actuator 1, the output value from the actuator element group 200 is changed by switching the number of actuator elements 2 concurrently operating. For example, when using McKibben artificial muscles for the actuator elements 2, the tensile force thereof being the output value is changed by switching the number of the operating artificial muscles.

When the actuator elements 2 provide the same output value under the same condition, e.g., having the same specifications, the output value from the actuator element group 200 including the actuator elements 2 will be a product of the number of the actuator elements 2 in operation (operated number) multiplied by the output value of one actuator element 2. In other words, when the number of the actuator elements 2 operating in parallel is two, the resultant output value will be twice the output value of one operating actuator element 2. When the number of the actuator elements 2 operating in parallel is n (where n is an integer), the resultant output value will be a product of the output value of one operating actuator element 2 multiplied by n. The output value from one actuator element 2 is herein referred to as a base output value. The base output value may also be referred to as a single output value, a unit output value, and a reference output value, for example.

The actuator 1 illustrated in FIG. 1 switches the operating state and the non-operating state of each of the actuator elements 2 to switch the output value from the actuator element group 200. Such an actuator 1 includes a fluid supply source 3, a pressure control valve 4, switching valves 51 to 54, and channel members 61 to 64 as a fluid supply system mechanism, for example.

The fluid supply source 3 supplies the fluid to the actuator elements 2. Examples of the fluid supply source 3 include a pump, a high-pressure tank, a gas cylinder, and an accumulator. A tank, a reservoir, or a drain pan may be provided upstream of the fluid supply source 3.

The pressure control valve 4 controls the pressure of the fluid in the channel 71 to be supplied into the actuator elements 2. The pressure control valve 4 can maintain the fluid pressure in the channel 71 at about a predetermined pressure. Examples of the pressure control valve 4 include a relief valve, a reducing valve, a sequence valve, a counterbalance valve, and an unloader valve.

The switching valves 51 to 54 are solenoid valves capable of switching the opening and closing of the channels, and the connections among the channels, in response to electric signals. Each of the switching valves 51 to 54 includes a valve unit (not illustrated) including a valve body, and a driver (not illustrated) for driving the valve body by an electromagnetic force of an applied electric signal.

Each of the switching valves 51 to 54 is a three-way solenoid valve provided with three ports (not illustrated) including a supply port, an actuator port, and a discharge port (return port), for example. In this example, the supply port is connected to the channel 71 controlled in pressure. The actuator port is connected to the channel 72 which leads to the actuator elements 2, and the discharge port is connected to a drain (low-pressure channel not illustrated). Each of the switching valves 51 to 54 is switched, in response to an electric signal, between a first state in which the actuator port becomes connected with the supply port and disconnected from the discharge port, and a second state in which the actuator port becomes connected with the discharge port and disconnected from the supply port. In the first state, the actuator elements 2 become connected to the channel 71 (high-pressure channel) pressure-controlled by the pressure control valve 4, via the channel 72 and the switching valves 51 to 54, to supply the fluid into the actuator elements 2. In the second state, the actuator elements 2 become connected with the drain via the channels 72 and the switching valves 51 to 54, and disconnected from the channel 71. In this manner, the fluid supply to the actuator elements 2 is stopped, and the fluid is discharged from the actuator elements 2. In other words, by switching the first state and the second state of the switching valves 51 to 54, the supply and non-supply of the fluid to the actuator elements 2 or the operating state and the non-operating state of the actuator elements 2 are switched. In the following, the first state is referred to as an ON state, and the second state is referred to as an OFF state. The configurations of the switching valves 51 to 54 and the channels 71 and 72 are not limited to the examples described herein. The switching valves 51 to 54 may be referred to as control valves.

The channel members 61 to 64 are interposed between the switching valves 51 to 54 and the actuator elements 2, respectively. Each of the channel members 61 to 64 includes a channel 72i inside. The channel 72i is at least a part of the channel 72 extending between corresponding one of the switching valves 51 to 54 and one or more actuator elements 2. The channel 72i is branched inside each of the channel members 62 to 64 connected to the actuator elements 2. Each of the channel members 61 to 64 includes a first port 6a and one or more second ports 6b. The first port 6a is positioned at one end of the channel 72i in each of the channel members 61 to 64 and one end is closer to the switching valves 51 to 54. The second port 6b is positioned at the other end of the channel 72i in each of the channel members 61 to 64, and the other end is closer to the actuator element 2.

A joint, such as a coupler, may be provided to a connection port (not illustrated) between the second port 6b and the actuator element 2. The second port 6b is an example of a fluid outlet from each of the channel members 61 to 64 to the actuator element 2.

The one or more actuator elements 2 that are connected to the channel members 61 to 64 are referred to as actuator units 21 to 24, respectively. The channel members 61 to 64 are collectively referred to as a channel component 600. The actuator elements 2 connected to each of the channel members 61 to 64 are operated by the fluid supply through the channels 72i of the channel members 61 to 64.

As illustrated in FIG. 1, the actuator 1 includes the channel members 61 to 64 and the actuator units 21 to 24 corresponding to the switching valves 51 to 54. The switching valves 51 to 54 control the operations of the corresponding actuator units 21 to 24.

The actuator 1 further includes a control unit 8 and a driving circuit 9, serving as a control system for inputting a control signal (an electric signal) to the switching valves 51 to 54. The control unit 8 generates a command signal to the driving circuit 9 based on a detection result of a sensor (not illustrated), on a command received from an external device (not illustrated), or on operation inputs by an operator to an operation unit (not illustrated). The control unit 8 is a computer such as an electronic control unit (ECU). The control unit 8 may include a controller, a main memory, and an auxiliary memory. The controller can implement the functions of the control unit 8 by executing calculations according to a computer program (application, software) installed therein. At least part of the functions of the control unit 8 may be implemented as hardware such as an application specific integrated circuit (ASIC), a field-programmable gate array (FPGA), or a digital signal processor (DSP).

The driving circuit 9 receives a command signal from the control unit 8, and outputs a control signal (electric signal) for switching the status of each of the switching valves 51 to 54 in response to the command signal. The driving circuit 9 includes a power supply circuit and switching elements, and switches the opening and closing of the switching elements in accordance with the command signal to output a control signal for causing a driver of the switching valves 51 to 54 to operate.

As illustrated in FIG. 1, in this embodiment, the numbers of the actuator elements 2 connected to the channel members 61 to 64 are different from one another. In FIG. 1, for example, the number of the actuator elements 2 connected to the channel member 61 to operate by the ON state of the switching valve 51 is one. The number of the actuator elements 2 connected to the channel member 62 to operate by the ON state of the switching valve 52 is two. The number of the actuator elements 2 connected to the channel member 63 to operate by the ON state of the switching valve 53 is four. The number of the actuator elements 2 connected to the channel member 64 to operate by the ON state of the switching valve 54 is eight. In other words, the number of the actuator elements 2 operated by the ON state of the switching valve 5i (where i represents the first digit of the reference numerals) is 2⁽ⁱ⁻¹⁾. Thus, among the multiple (four, in this example) switching valves 51 to 54 included in the actuator 1, the numbers of the actuator elements 2 to operate by the ON state of the switching valves 51 to 54 differ from one another and are set to a power of two.

As described earlier, in this embodiment, the output values from all of the actuator elements 2 are substantially the same. That is, the output value from the actuator element group 200 operated by the ON state of the i-th switching valve 5i is approximately 2⁽ⁱ⁻¹⁾ times the base output value, which is the output value from one actuator element 2.

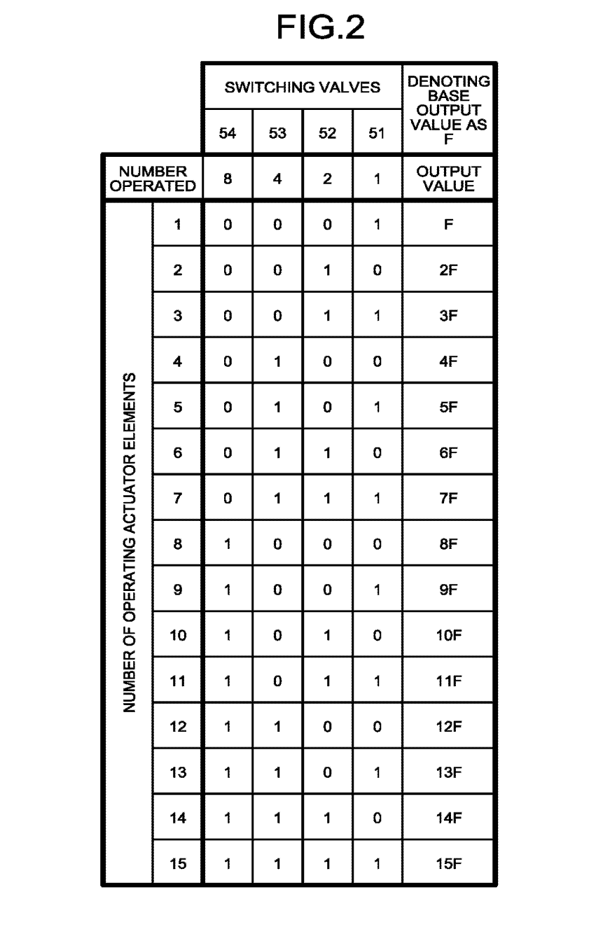

FIG. 2 is a table representing the total numbers of actuator elements 2 operated by switching the ON state and the OFF state of the switching valves 51 to 54, and the resultant output values from the actuator element group 200. As described above, the number of the actuator elements 2 operated by the ON state of the switching valve 51 is one. The number of the actuator elements 2 operated by the ON state of the switching valve 52 is two. The number of the actuator elements 2 operated by the ON state of the switching valve 53 is four, and the number of the actuator elements 2 operated by the ON state of the switching valve 54 is eight. In FIG. 2, the ON state is denoted by 1, and the OFF state is denoted by 0. That is, by switching the ON state and the OFF state of the switching valves 51 to 54 as illustrated in FIG. 2, the number of the operating actuator elements 2 can be switched in increments of one from one to fifteen. The output value from the actuator element group 200 can be switched in increments of one from a factor of 1 (base output value) to fifteen. It will be understood that every decimal number can be represented by switching each digit of the binary (each bit) between 0 and 1, enabling this control. FIG. 2 shows the output values when the base output value is denoted as F.

As explained above, the actuator 1 can switch (change) the output value to one target or in the same location, by switching the operating actuator elements 2 arranged in parallel, specifically, the numbers or combinations of concurrently operating actuator elements 2.

In the actuator 1, the output value from n actuator units 21 to 24 (2n) (where n is an integer equal to or more than 2) is approximately 2ⁱ times the base output value (where i is an integer equal to or more than 0 and equal to or less than n-1). By switching the operating states of the n actuator units 21 to 24 (2n), the output value from the actuator element group 200 (the actuator 1) can be switched in increments of one time (base output value) from a factor of one to 2ⁿ−1 of the base output value. That is, with a smaller number of switching valves 51 to 54 than that of the actuator elements 2, the actuator element group 200 can output the output values that are switched in increments of the number equal to the number of the actuator elements 2. This can, for example, reduce the size or the weight of the actuator 1, or reduce the number of parts from the one including the same numbers of the switching valves 51 to 54 and the actuator elements 2, resulting in reducing the labor or the costs in manufacturing the actuator 1.

Each of the n actuator units 21 to 24 (2n) (where n is an integer equal to or more than 2) includes 2ⁱ actuator elements 2 (where i is an integer equal to or more than 0 and equal to or less than n-1). Each of the n channel members 61 to 64 (6n) (where n is an integer equal to or more than 2) has 2ⁱ second ports 6b (outlets) (where i is an integer equal to or more than 0 and equal to or less than n-1). Thus, for example, by setting the number of the actuator elements 2 connected to the channel members 61 to 64 to a power of two, the actuator units 21 to 24 can be relatively easily configured to generate output values of powers of two.

Each of the actuator elements 2 is a McKibben artificial muscle and contracts in response to the fluid supply, and the output value represents a tensile force from the contraction of one or more actuator elements 2, as an example The actuator 1 according to the present embodiment is applicable to an artificial muscle system. According to this embodiment, each of the actuator elements 2 can serve as a muscle fiber with a relatively small diameter, and the actuator element group 200 can serve as a muscle fiber group, that is, artificial muscles which mimic a bundle of muscles. The number of the second ports 6b (outlets) may be a number other than 2ⁱ.

### Second Embodiment

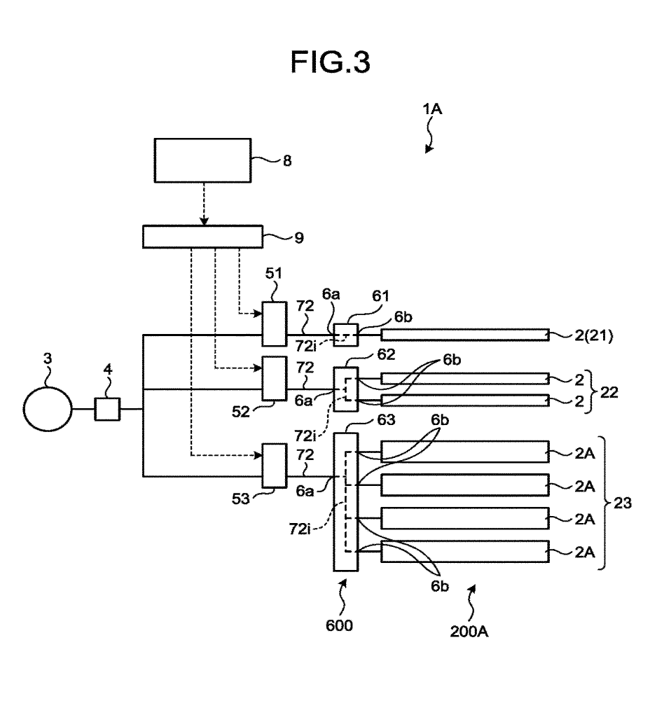

FIG. 3 is a schematic of a general configuration of an actuator 1A according to a second embodiment. The second embodiment includes same or like elements as those in the first embodiment. Hence, the second embodiment can also attain the same results (effects) based on the same or like elements.

In this embodiment, however, the output value from actuator elements 2A of the actuator unit 23 is more than the output value from the actuator elements 2 of the actuator unit 21 or 22, and is twice the base output value, for example. The diameter (inner diameter) of the fluid container (tube) of each of the four actuator elements 2A is set to generate the output value twice the output value of each actuator element 2. For example, to acquire an output value twice the base output value, when the lengths and the sleeve-winding angles of the actuator elements 2 and the actuator elements 2A are the same, the diameter of the actuator elements 2A is set to about √2 times the diameter of the actuator elements 2. Thereby, the output values from the actuator units 21, 22, and 23 can be set to one time, twice, and eight times the base output value (output value of the actuator elements 2), respectively. Thus, the present embodiment can provide the actuator 1A in which the output value of the actuator element group 200A can be increased (changed) nonlinearly with respect to the numbers of the operating actuator elements 2, 2A.

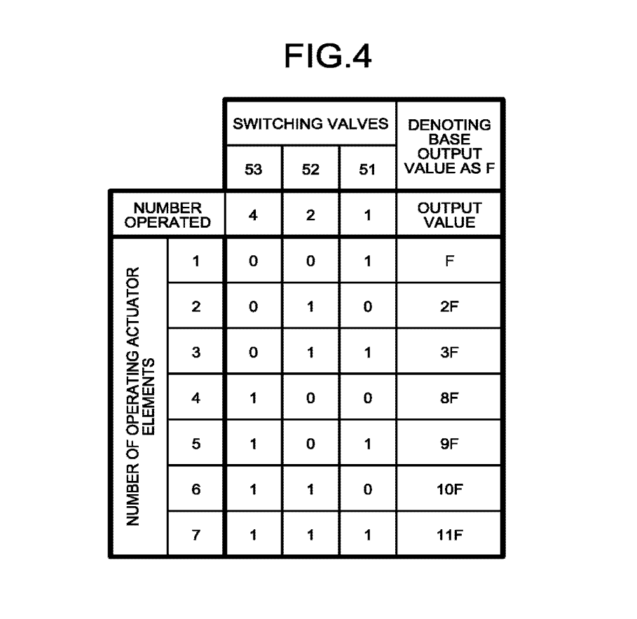

FIG. 4 is a table representing the total numbers of the operating actuator elements by switching the ON/OFF states of the switching valve 51 to 53, and the output values from the actuator element group 200A, when the actuator unit 23 includes the actuator elements 2A. It can be seen that the output value increases sharply while the switching valve 53 is in the ON state. FIG. 4 shows the output values when the base output value is denoted as F.

This embodiment is exemplified by, but not limited to the larger output value from the entire actuator elements 2A of the actuator unit 23 than the base output value or the output value from the actuator elements 2 of the other actuator units 21, 22. The output value from at least one of the actuator elements 2A of one of the actuator units 21, 22, and 23 may be larger or smaller than, that is, may be different from the output value from the other actuator elements 2, for example.

If the lengths and the sleeve-winding angles of the actuator elements are the same, setting the diameter of the actuator elements to √N times larger makes it possible to obtain an output value N times the base output value.

When the fluid flows into the actuator elements at the same flow rate, the response speed of the actuator elements changes depending on the diameter size. Thus, to achieve a quick movement, the actuator elements with a smaller diameter are driven while to achieve a higher-load movement at a slower response speed, the actuator elements with a larger diameter are driven, enabling operations considering the response speed. For example, with use of the actuator elements as artificial muscles, they can reproduce operations corresponding to fast muscles and slow muscles of a person and the force or a movement of a hand holding a ball or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. The configurations and the shapes disclosed in the embodiments may also be partially replaced. Specifications such as the configurations and the shapes (e.g., structures, types, directions, shapes, sizes, lengths, widths, thickness, heights, angles, numbers, arrangements, positions, and materials) may be changed as appropriate.

For example, an actuator including actuator units having different numbers of actuator elements (numbers of outlets of channel components) can generate various different output values by changing the numbers or the combinations of the actuator elements, which enables a reduction in the number of switching valves. In other words, the present invention is not limited to the configuration in which each of the actuator units outputs a value that is a power of two of the base output value, or in which the number of the actuator elements is a power of two, as long as the actuator includes actuator units having different numbers of actuator elements.

Furthermore, the actuator according to any of the embodiments can be applied to other devices other than artificial muscle system, and the actuator element may be any actuator element that is not for an artificial muscle. Furthermore, the output value may represent any force other than the tensile force (contraction), and may represent any physical quantity in a dimension other than the force. Furthermore, the actuator according to any of the embodiments can also be used with a liquid or any substance having fluidity, as well as gas, for example.

What is claimed is:

1. An actuator comprising
a plurality of channel members each including a first port into which fluid flows and a second port from which the fluid flows out, wherein
at least one of the channel members includes a different number of second ports from a number of first ports.

2. The actuator according to claim 1, wherein, when the number of the channel members is n where n is an integer equal to or more than 2, the number of the second ports of an n^{th} channel member is 2ⁱ where i is an integer equal to or more than 0 and equal to or less than n-1.

3. The actuator according to claim 1, further comprising a plurality of actuator units configured to operate when supplied with the fluid from the channel members, wherein
each of the actuator units includes a plurality of actuator elements connected to the respective second ports.

4. The actuator according to claim 3, wherein the actuator elements of at least one of the actuator units include at least one actuator element having a different diameter.

5. A channel component comprising
a plurality of channel members each including a first port into which fluid flows and a second port from which the fluid flows out, wherein
at least one of the channel members includes a different number of second ports from a number of first ports.

6. The channel component according to claim 5, wherein, when the number of the channel members is n where n is an integer equal to or more than 2, the number of the second ports of an n^{th} channel member is 2ⁱ where i is an integer equal to or more than 0 and equal to or less than n-1.
